(19) United States
(12) Patent Application Publication
(10) Pub. No.: US 2026/0252787 A1
(43) Pub. Date: Aug. 27, 2026

(54) LANGUAGE MODEL FOR DOCUMENT GENERATION

(71) Applicant: Intuit Inc., Mountain View, CA (US)

(72) Inventors: Vishal Kumar SINGH, Bengaluru (IN); John SAMUEL, Banglore (IN); Murari LAL, Bangalore (IN); Srivathsal VENKATARAMU, Bangalore (IN); Akash -, Bengaluru (IN)

(73) Assignee: Intuit Inc., Mountain View, CA (US)

(21) Appl. No.: 19/061,973

(22) Filed: Feb. 24, 2025

(51) Int. Cl. G06F 40/12; G06F 40/20

(52) U.S. Cl. CPC G06F 40/12; G06F 40/20

(57) ABSTRACT

A method includes obtaining an extracted document corresponding to a customer. The extracted document includes a multitude of canonical field identifiers and a corresponding multitude of canonical field values. A prompt is generated for a document conversion language model (LM) to convert the extracted document. The converted document and a client-application-generated (CAG) document corresponding to the customer are compared to identify differences between the converted document and the CAG document. The method further includes generating a subsequent prompt to the document conversion LM including the differences as inputs. The method further includes processing the subsequent prompt by the document conversion LM to generate a natural language summary of the identified differences. The method further includes presenting the identified differences and the natural language summary in a client application.

### BACKGROUND

Enterprises offer a myriad of software applications and platforms for customers, for managing finances, tax returns, small business bookkeeping, generating reports, managing school records, etc. The customer may be an individual, or a business entity. The output of these software applications may be a generated document including information such as customer self-reported data, derived calculations from self-reported data, self-reported grades, test scores, and balance sheets. The documents generated by the software applications may be referred to as client-application-generated documents. Customers may be required to submit these client-application-generated documents to a regulatory or compliance agency, such as federal and state tax departments, school, or university admissions, etc. The agency may process the customer submissions, verifying the data and computations for accuracy against supporting documents associated with the customer, for example, income tax declarations and withholding statements from employers of the customer, bank statements, or birth and social security records, and university enrollment numbers. The supporting documents may be received at the agency from external sources, such as employers, schools and universities, investment companies, banks, etc. The supporting documents may be collectively referred to as canonical documents.

In the event that the customer submission is determined to have a discrepancy with the canonical documents, the agency may reject the customer submission and generate a notice. When the customer receives a notice of a rejection, corrective action should be taken. The customer receives a notice of the rejection. Ideally, a software application that is used to generate the customer submission should be used to interpret the notice of the rejection and take corrective actions. However, because of the variability in the notices, a software application cannot interpret the notices and identify the reason for the rejection. Thus, a technical problem arises in the ability of the software application to autonomously identify the root cause of a rejection, necessitating time-consuming and costly manual intervention. A further technical challenge exists in the necessity to repeatedly re-program the software application to extend compatibility to diverse canonical documents in varied formats that may be regularly updated.

### SUMMARY

In general, in one aspect, one or more embodiments relate to a method. The method includes obtaining an extracted document corresponding to a customer. The extracted document includes a multitude of canonical field identifiers and a corresponding multitude of canonical field values. The method further includes generating a prompt to a document conversion language model (LM). The prompt includes the extracted document as a first input, and an instruction to convert the extracted document. The method further includes processing the prompt by the document conversion LM to obtain a converted document. The method further includes comparing the converted document and a client-application-generated (CAG) document corresponding to the customer to identify a difference between the converted document and the CAG document. The method further includes generating a subsequent prompt to the document conversion LM including the difference as an input. The method further includes processing the subsequent prompt by the document conversion LM to generate a natural language summary of the identified difference. The method further includes presenting the identified difference and the natural language summary in a client application.

In general, in one aspect, one or more embodiments relate to a system. The system includes at least one computer processor, and a document extraction tool, executing on the at least one computer processor. The document extraction tool is configured to obtain an extracted document corresponding to a customer, including a multitude of canonical field identifiers and a corresponding multitude of canonical field values. The system further includes a document conversion language model (LM), executing on the at least one computer processor. The document conversion LM is configured to process a first prompt to obtain a converted document, and process a second prompt by the document conversion LM to generate a natural language summary of a first difference. The system further includes a reconciliation engine, executing on the at least one computer processor. The reconciliation engine is configured to generate the first prompt to the document conversion LM including the extracted document as a first input, and a first instruction to convert the extracted document. The reconciliation engine is further configured to compare the converted document and a client-application-generated (CAG) document corresponding to the customer to identify the first difference between the converted document and the CAG document. The reconciliation engine is further configured to generate the second prompt to the document conversion LM including the first difference as a second input, and present the first difference and the natural language summary in a client application.

Other aspects of one or more embodiments will be apparent from the following description and the appended claims.

### BRIEF DESCRIPTION OF DRAWINGS

FIG. 1 shows a computing system in accordance with one or more embodiments.

FIG. 2 shows a flowchart of a method in accordance with one or more embodiments.

FIG. 3 shows a flowchart of a method in accordance with one or more embodiments.

FIG. 4 shows an example of training data input in accordance with one or more embodiments.

FIG. 5 shows an example of outputs from selected system components in accordance with one or more embodiments.

FIGS. 6A and 6B show a computing system in accordance with one or more embodiments.

Like elements in the various figures are denoted by like reference numerals for consistency.

### DETAILED DESCRIPTION

One or more embodiments are directed to converting a canonical document associated with a customer to a human and machine-readable data-interchange format. A canonical document is a supporting document for a client-application-generated (CAG) document and is assumed to be accurate. The data-interchange format is in the same format as a CAG document. By matching formats, embodiments may compare and identify differences between the documents. One or more embodiments further summarize the differences in natural language.

To perform the comparison, a document conversion language model (LM) is specially trained to classify data entities obtained from a canonical document with labels and context corresponding to the CAG document. The data entities of the canonical document may include canonical field identifiers and canonical field values. The trained document conversion LM generates a converted document. The converted document includes the canonical field identifiers classified with labels that are CAG field identifiers from the CAG document. The converted document is in a data-interchange format that matches the data-interchange format of the CAG document. Further, the canonical field identifiers of the converted document are replaced by the document conversion LM with the classification labels.

A reconciliation engine may then compare the converted document and the CAG document to identify differences between field values of matching field identifiers of the documents. The reconciliation engine may generate prompts to the document conversion LM with the identified differences. The document conversion LM may identify the differences between the corresponding data entities and generate a natural language description of the differences.

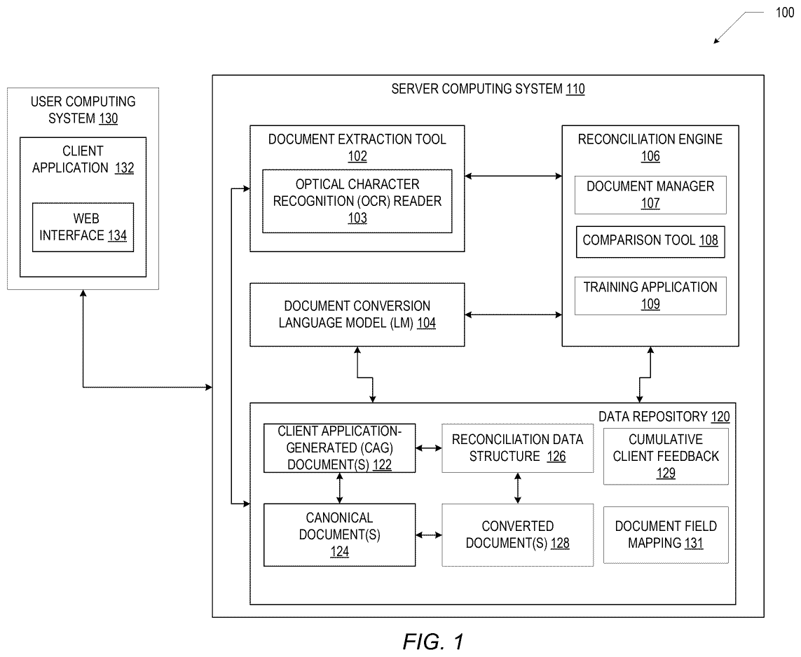

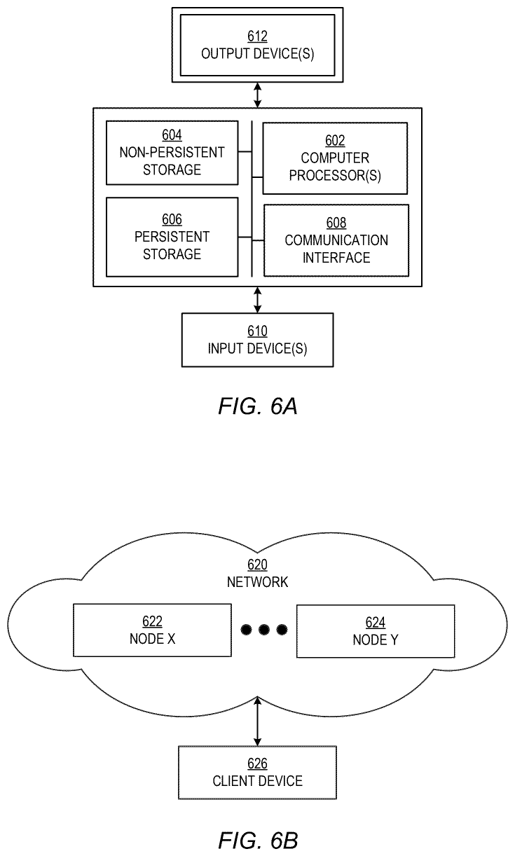

Attention is now turned to the figures. FIG. 1 shows a computing system 100, in accordance with one or more embodiments. The computing system 100 of FIG. 1 includes a server computing system (110). The server computing system (110) is one or more computer processors, data repositories, communication devices, and supporting hardware and software. The server computing system (110) is configured to execute one or more applications, such as the document extraction tool (102), the document conversion language model (LM) (104), and the reconciliation engine (106). The server computing system (110) includes a computer processor. The computer processor is one or more hardware or virtual processors which may execute computer readable program code that defines one or more applications, such as the document extraction tool (102), the document conversion LM (104), and the reconciliation engine (106). The server computing system (110) may be in a distributed computing environment. An example of a computer system and network that may form the server computing system (110) is described with respect to FIG. 6A and FIG. 6B. An example of the computer processor is described with respect to the computer processor(s) (602) of FIG. 6A.

The server computing system (110) shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) includes one or more CAG document(s) (122). CAG document(s) (122) may be generated by server-side applications, or server-side services, which operate in conjunction with one or more instances of the client application (132) executing on one or more user computing system(s) (130). A CAG document (122) includes fields. A field is a discrete contiguous portion of the CAG document that includes a value of an entity.

For example, consider the scenario in which the CAG documents are financial related documents. CAG documents (122) may include one or more fields related to the personal information of a particular customer. For example, the fields may include customer name, social security number, date of birth, etc. CAG document(s) (122) may further include fields related to information that may be self-reported by the particular customer, for example, wages earned from employment, earnings from investments, etc., deductions taken for the current tax year, etc. Additionally, CAG document(s) (122) may include fields related to derived information. For example, net taxable income may be a field in which the field value is calculated by subtracting the total deductions from the total wages earned.

Fields related to derived information may be populated by the business logic of the client application (132) and/or server-side applications or services working in conjunction with the client application (132). Further, fields pertaining to personal or self-reported information may be populated with values obtained by customer interaction with the client application (132). Additionally, or alternatively, the fields pertaining to self-reported information may be populated by the business logic of the client application subsequent to receiving an upload of reporting documents from a customer, such as a W-2 wages and tax forms. Fields of CAG documents have field identifiers, and field values. These may be referred to as “CAG field identifiers” and “CAG field values.”

The CAG document further includes a context associated with the CAG field identifiers. The context is an utterance in natural language including information about the field. The context may further include information generated by the logic of the client application or an explanation of how the field is populated in case of a derived field.

For example, the context may include “Add the deductions from rows A2 to A4 to obtain this value,” or an explanation of a date format, such as “Enter date in MM/DD/YYYY format,” an instruction of how to use an input document to populate a field, such as “Enter your wages shown in section A, entry 2 of your W2 copy in this field.”

The file format of the CAG document may be a format that is machine-readable and understandable. A machine-readable file format may be processed by a computer without human intervention. Machine-readable file formats may facilitate software programs and code processing documents in the machine-readable file formats to extract and manipulate data efficiently. For example, text-based portable document format (PDF) documents may be machine-readable and understandable. In certain cases, machine-readable document formats may be data-interchange formats that are human-readable/writable. In addition, these data-interchange formats may be readable/generatable by software programs and code executing on a computer. Data-interchange formats may be used for transmitting data in web applications. For example, JavaScript Object Notation (JSON) format is a data-interchange format. JSON is a structured format with key-value pairs, facilitating parsing by software programs and code executing on computers. The CAG document may be in JSON format. Documents in JSON format are known as JSON documents. JSON documents may be readable by several machine learning models, server applications and services, etc. Some additional examples of data-interchange formats are eXtensible Markup Language (XML), “YAML Ain't Markup Language” (YAML), etc. The CAG documents (122) may be stored in the data repository (120) in a document store, for example, MongoDB®.

The data repository (120) further includes one or more canonical document(s) (124). Canonical documents (124) refer to documents related to an individual that are generated by external sources. Notably, canonical documents may not include data or records that may be self-reported by the individual. The external sources may include government bodies, healthcare providers, educational institutions, employers, etc. For example, an individual's birth records may be generated at the birth registry department of the local government office at the location of the individual's birth. These birth records may be retrieved by various government organizations, educational institutions, etc. over the course of time. When the individual is enrolled in a school, the self-reported date of birth of the individual may be checked against the birth records of the individual in the birth registry department of the local government office of the individual's birthplace. The birth record in the local government office may be referred to as the “canonical” record. Thus, a canonical document may include canonical records related to an individual or juristic entity, generated by external sources.

By way of another example, the employers of an individual may generate a W-2 form which is a record of wages earned and tax deductions for the individual for a particular financial year. The individual may receive this W-2 form to be used in self-reporting when filing a tax return. Parallelly, the employers may send the W-2 form and a W-3 form to the Internal Revenue Service (IRS). The W-2 and W-3 form may be used by the IRS to verify the self-reported wage and tax information of the individual. Thus, the data from the W-2 and W-3 form sent by the employers to the IRS for that individual may constitute the data of the canonical document corresponding to the individual. In other words, the canonical document is a ground truth document. The canonical document may be used to verify self-reported data by the individual. Further, the canonical document may be used to verify data of a CAG document corresponding to the individual that is output by a software application.

The format of canonical documents may vary depending on the source of the canonical document, the location and time where/when the canonical document was first generated, and other factors. For example, some birth certificates may be typed on paper forms. The images of these forms may be stored online at a government-owned-and-operated digital record storage facility. In another example, school records and transcripts may be data records stored in databases of educational institutions, retrievable as PDF documents or paper documents.

In one or more embodiments, canonical documents (124) that are imported into the data repository (120) may not be in the data-interchange format of the CAG documents. The canonical document(s) (124) may therefore be stored in their native format in the data repository (120). Examples of data storage for variable format documents include document-oriented databases such as MongoDB®, file storage systems such as Amazon® S3, Google® Cloud Storage, etc. In some cases, Elasticsearch® may be used with a file ingestion tool such as Filebeat®. Canonical documents may include fields having field identifiers and field values, which may be referred to as “canonical field identifiers” and “canonical field values,” respectively.

The data repository (120) further includes one or more converted document(s) (128). The one or more converted document(s) (128) are versions of the canonical document(s) (124), converted into a data-interchange format. Notably, the data-interchange format of the converted document(s) (128) may match the data-interchange format of the CAG document(s) (122). The conversion of the “converted” document refers to canonical field identifiers obtained from the canonical document being “converted” to CAG field identifiers of the CAG document. Thus, the converted document(s) (128) may include “converted field identifiers” which are CAG field identifiers. However, the field values of the “converted field identifiers” are unmodified copies of the canonical field values of the canonical document.

For example, a canonical field identifier in the canonical document may be “Wages earned from Employer X” and the canonical field value may be “$50,000.” A corresponding CAG field identifier in the CAG document may be “Section A, Code 801.” Further, the CAG field value in the CAG document may be “$45,000.” The converted document, therefore, may include the “converted field identifier,” converted from “Wages earned from Employer X” to “Section A, Code 801.” However, the field value corresponding to the “converted field identifier” is the same as in the canonical field value of the canonical document, namely, “$50,000.”

The converted document may further include a context and description of the canonical field identifiers of the corresponding canonical document(s) (124). Additionally, the converted document may include a context and description of the CAG field identifiers of the corresponding CAG document(s) (122).

Prior to conversion, the canonical document may undergo processing by the document extraction tool (102) to obtain an intermediate or transient version of the canonical document, known as an “extracted” document. The extracted document is described in further detail, in reference to the document extraction tool (102).

A one-to-one correspondence may exist between the converted document(s) (128) and the canonical document(s) (124). One or more canonical document (124) and one or more CAG documents may correspond to a same customer. For example, an individual who is a customer of a tax preparation application may obtain two CAG documents from the tax preparation application-a federal tax return and a state tax return. These tax returns may be generated and stored in a data-interchange (e.g., JSON) format. The IRS may be an external source of canonical documents associated with the individual. There may be a single canonical document corresponding to the individual, namely, an IRS transcript. Further, there may be a single converted document corresponding to the canonical document, such as a version of the IRS transcript, in JSON format. Thus, in the example, the customer is associated with two CAG documents. The customer is further associated with one canonical document (the IRS transcript) and a corresponding converted document. Converted document(s) (128) may be stored in data storage or data structures similar to CAG documents.

The data repository (120) further includes a reconciliation data structure (126). There may be more than one reconciliation data structure(s) (126). A reconciliation data structure (126) stores an identified difference between a CAG field value of the CAG document (122) and a corresponding canonical field value of the converted document (128) associated with an individual. The converted document (128) includes converted field identifiers and canonical field values of a corresponding canonical document (124) associated with the individual. Thus, the identified difference is a discrepancy between a CAG field value in the CAG document and a corresponding canonical field value in the canonical document.

For example, the customer may have erroneously reported the total wages earned. The CAG document and the converted document associated with the customer may be compared. A discrepancy may be identified between the total wages earned canonical field value obtained from the canonical document (now in the converted document), and in the total wages earned field value of the CAG document. (e.g., CAG document->total wages earned: $45,000; converted document->total wages earned: $50,000).

In one or more embodiments, the reconciliation data structure (126) may be a list, or table, of CAG field identifiers, canonical field values and CAG field values. The reconciliation data structure (126) may further include context information from the converted document and the CAG document corresponding to the CAG field identifier. Other data structures and storage may be possible.

The data repository further includes a document field mapping (131). The document field mapping (131) is a logical map that maps canonical field identifiers of canonical document(s) (124) to CAG field identifiers of CAG document(s) (122). The document field mapping (131) may be used by the training application to develop a training dataset for the document conversion LM (104). Field identifiers may include field names. Further, field identifiers may include document layout information, indicating the physical location of the field in a page of the document, field context and other metadata. Some examples of data structures storing the document field mapping (131) include dictionaries (hash maps), lists of tuples, data frames, etc.

The data repository further includes a cumulative client feedback (129). The cumulative client feedback (129) includes customer feedback generated by customers of the client application (132). The customer feedback may include correction information related to incorrect field mapping and correspondingly misidentified differences in the reconciliation data structure(s) (126). The customer feedback may be obtained via the web interface (134) of the client application (132). The customer feedback is accumulated over time into the cumulative client feedback (129). In a re-training phase, the cumulative client feedback (129) may be used to update the document field mapping (131) and the training dataset for the document conversion LM (104). Thus, the document conversion process is updated and corrected by re-training the document conversion LM with updated document field mapping (131) and training datasets.

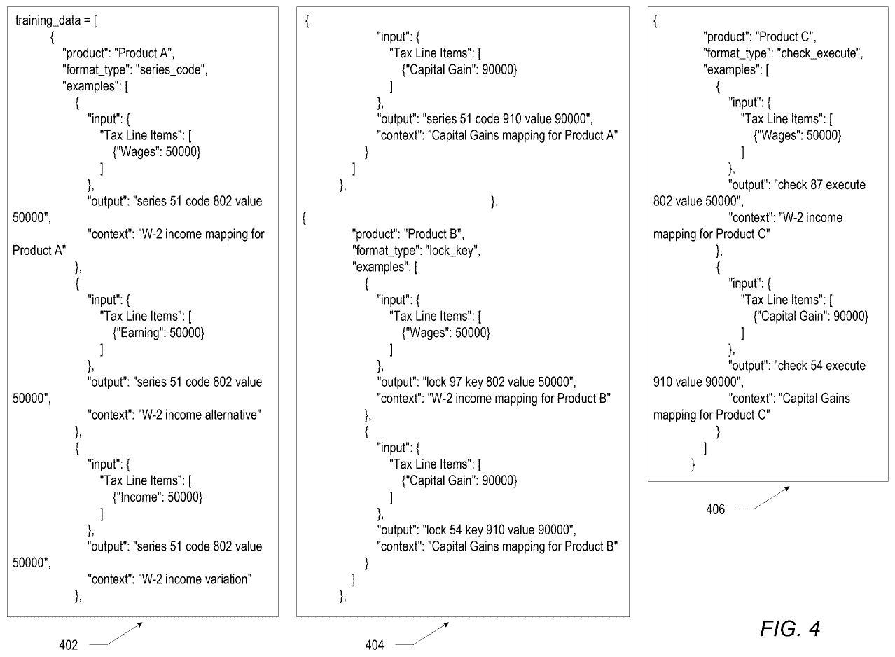

The server computing system (110) further includes a document extraction tool (102). The document extraction tool (102) further includes an optical character recognition (OCR) reader (103). The document extraction tool (102) is software or application-specific hardware which, when executed by the computer processor, extracts canonical field identifiers, canonical field values, context, and descriptions from canonical documents. The extraction process may include OCR-based extraction of canonical field identifiers and canonical field values from the canonical document. Additionally, or alternatively, extracting may include text processing of the canonical document to extract canonical field identifiers and canonical field values from the canonical document. The output of the document extraction tool (102) is referred to as an extracted document. The extracted document may be considered to be an “intermediate,” or “transient,” version of the canonical document, prior to conversion by the document conversion LM (104). The format of the extracted document may be in a data-interchange format, such as JSON. Notably, the field identifiers and field values of the extracted document are the same as the canonical field identifiers and canonical field values of the canonical document. The extracted document may further be processed by the document conversion LM (104), to generate a converted document. The processing of the extracted document may entail “conversion” of the field identifiers in the extracted document to CAG field identifiers of CAG documents. The conversion may be based on the document field mapping (131). An example of mapping of inputs (obtained from an extracted document) to outputs (matching the CAG document) is described in reference to FIG. 4.

The server computing system (110) further includes a document conversion LM (104). The document conversion LM (104) may be a pre-trained language model, for example, Bidirectional Encoder Representations from Transformers (BERT)-base cased or BERT-base uncased. As a general overview, BERT models may be pre-trained using two main objectives: Masked Language Modeling (MLM), in which a percentage of words are randomly masked and the model is tasked with predicting the masked words, and Next Sentence Prediction (NSP) in which the language model is tasked to predict if two sentences follow each other in the original text.

The document conversion LM (104) undergoes further training, to classify canonical field identifiers obtained from extracted documents with labels that are CAG field identifiers of CAG documents. Further, the document conversion LM replaces or substitutes the canonical field identifiers with the classification labels. Thus, the output of the trained document conversion LM (104) is a converted document having a set of CAG field identifiers and corresponding canonical field values. The classified field identifiers of the extracted document are effectively “converted” to field identifiers of the CAG documents.

The server computing system (110) further includes a reconciliation engine (106). The reconciliation engine (106) is software or application-specific hardware which, when executed by the computer processor controls and coordinates operation of the software or application-specific hardware described herein. Thus, the reconciliation engine (106) may control and coordinate execution of the document extraction tool (102), and the document conversion LM (104).

The reconciliation engine (106) further includes a document manager (107). The document manager (107) is software or application-specific hardware, which, when executed by the computer processor, may control and coordinate execution of the document extraction tool (102) and the document conversion LM (104). For example, the document manager (107) may programmatically invoke the document extraction tool (102) to generate an extracted document from an updated version of a received canonical document. Further, the document manager (107) may subsequently programmatically invoke the document conversion LM (104) to convert the extracted document to a converted document. The document manager (107) may order the execution of the document extraction tool (102) and the document conversion LM (104), sequentially, or in parallel.

The reconciliation engine (106) may further include a comparison tool (108). The comparison tool (108) is software or application-specific hardware, which, when executed by the computer processor, may compare a converted document with a CAG document. The converted document and the CAG document may be associated with an individual. The output of the comparison tool (108) may be one or more identified differences between the converted document and the CAG document. The identified differences may be stored in the reconciliation data structure (126).

The reconciliation engine (106) further includes a training application (109). The training application (109) is software or application-specific hardware which, when executed by the computer processor, further trains the document conversion LM (104) to classify canonical field identifiers of an extracted document with CAG field identifiers. In one or more embodiments, the training application (109) may be a machine learning model training platform. Examples of machine learning model training platforms include Amazon® SageMaker, Google® AI Platform, Microsoft® Azure Machine Learning, Databricks®, TensorFlow® Extended, H2O. ai, Hugging Face, etc.

The system 100 shown in FIG. 1 also may include one or more user computing systems (130). The user computing systems (130) may be considered remote or local. A remote user computing system may be operated by a third-party (e.g., an end user of a chatbot) that does not control or operate the server computing system (110) of FIG. 1. Similarly, the organization that controls the server computing system (110) of FIG. 1 may not control or operate the remote user computing system(s) (130). Thus, a remote user computing system(s) (130) may not be considered part of the system 100 of FIG. 1. In contrast, a local user computing system(s) (130) may be operated under the control of the organization that controls the server computing system (110) of FIG. 1. Thus, a local user computing system(s) (130) may be considered part of the system 100 of FIG. 1.

A customer of the client application (132) executing on the user computing system (130) may interact with the client application (132) via the web interface (134). The client application may be a computer program product offered by an enterprise or organization controlling the server computing system (110), for example, a tax filing application, an educational institution portal for students and faculty, a personal finance application, a health insurance provider customer portal, etc. The customer may be an individual or business entity using the product offering.

While FIG. 1 shows a configuration of components, other configurations may be used without departing from the scope of one or more embodiments. For example, various components may be combined to create a single component. As another example, the functionality performed by a single component may be performed by two or more components.

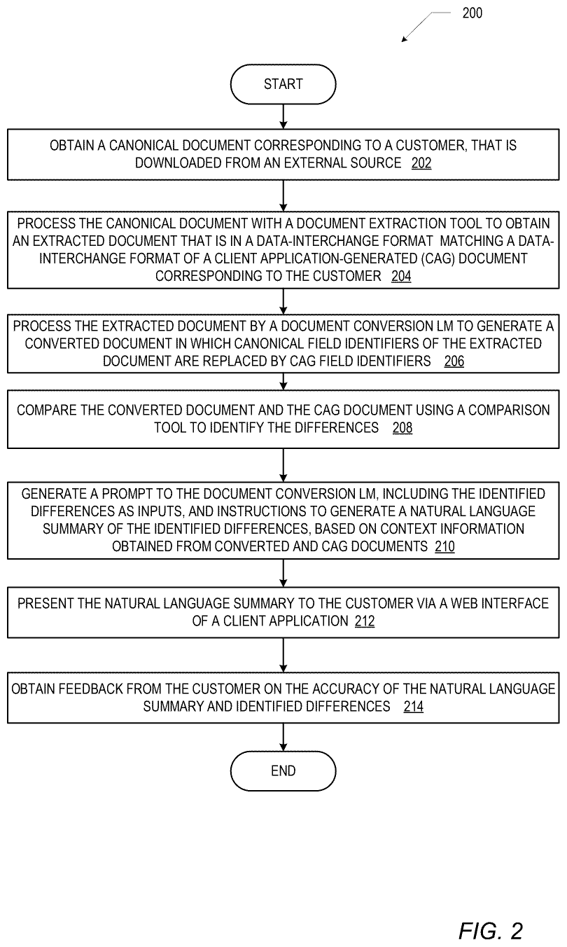

FIG. 2 shows a flowchart 200 of a method for identifying discrepancies between a canonical document and a client-application-generated document to display to a customer, with a natural language explanation of the discrepancy, in accordance with one or more embodiments. The method of FIG. 2 may be implemented using the system of FIG. 1 and one or more of the steps may be performed on or received at one or more computer processors. While the various steps in flowchart 200 are presented and described sequentially, at least some of the steps may be executed in different orders, may be combined, or omitted, and at least some of the steps may be executed in parallel. Furthermore, the steps may be performed actively or passively.

In Block 202, a canonical document is obtained. The canonical document may correspond to a customer. The canonical document may be downloaded into the data repository from an external data source. The customer may be an individual or an enterprise paying to use a client application. In one or more embodiments, the canonical document may include multiple canonical field identifiers and corresponding multiple canonical field values. In one or more embodiments, Block 202 of the flowchart 200 may be triggered by the reconciliation engine. For example, the reconciliation engine may receive a trigger prompting the reconciliation engine to obtain a canonical document corresponding to a particular customer. The trigger may be issued by a server-side application corresponding to the client application, which implements business logic to validate and cross-check CAG documents of the customer. Thus, the reconciliation engine may be programmatically invoked (triggered) to obtain one or more canonical documents corresponding to the customer.

In Block 204, the canonical document is processed with a document extraction tool to obtain an extracted document that is in a data-interchange format matching a data-interchange format of a CAG document corresponding to the customer. In one or more embodiments, the reconciliation engine may further invoke the document extraction tool to process the canonical document. A goal of processing the canonical document may be to obtain a version of the canonical document in a data-interchange format that matches the data-interchange format of CAG documents corresponding to the customer. In one or more embodiments, the document extraction tool may process the canonical document corresponding to the customer, to obtain a canonical field identifier and a corresponding canonical field value. For example, the document extraction tool may use optical character recognition to extract textual information from images. Further, textual information may be structured into logical formats such as key-value pairs, tables, etc. The document extraction tool may further perform layout analysis of the canonical document to recognize sections, line items, etc. Thus, the output generated by the document extraction tool may be an extracted document. The extracted document includes the information of the canonical document in a data-interchange format. The data-interchange format may be the same as the data-interchange format of CAG document(s) corresponding to the customer. Further, the extracted document may include at least one canonical field identifier and corresponding canonical field value. The canonical field identifier and corresponding canonical field value may be representative of various types of data entities, including key-value pairs, tables, plain text, line items, etc.

In Block 206, the extracted document is processed by a document conversion LM to generate a converted document in which canonical field identifiers of the extracted document are replaced by CAG field identifiers. In one or more embodiments, a prompt to the document conversion language model (LM) may be generated. The prompt may include the extracted document as input, and an instruction to convert the extracted document. The instruction may further include specific directions to convert the extracted document by classifying the multiple canonical field identifiers with multiple CAG field identifiers corresponding to the CAG document. Additionally, the instruction may include specific directions to replace the (classified) multiple canonical field identifiers of the extracted document with the corresponding multiple CAG field identifiers, to obtain the converted document. The document conversion LM may process the extracted document in accordance with the prompt to obtain a converted document. In one or more embodiments, the reconciliation engine may transmit the prompt to the document conversion LM via application programming interface (API) calls.

In Block 208, the converted document and the CAG document are compared to identify the differences between the documents. In one or more embodiments, the converted document and the CAG document corresponding to the customer are compared to identify a first difference between the converted document and the CAG document. In one or more embodiments, the reconciliation engine may compare a canonical field value of the converted document corresponding to a first CAG field identifier of the converted document, and a CAG field value of the CAG document corresponding to a matching second CAG field identifier of the CAG document. Responsive to a mismatch between the canonical field value and the CAG field value, the reconciliation engine may identify the first difference. For example, the converted document may include the following: “Series 51 code 810” as the CAG field identifier and “$50000” as the canonical field value. The reconciliation engine may check the CAG field value in the CAG document corresponding to the CAG field identifier “Series 51 code 810.” The CAG field value may be “$45000.” Since the canonical field value and the CAG field value do not match, the reconciliation may identify the first difference as “Series 51 code 810”; canonical value $50000; customer value $45000; “W-2 income mapping for section A.”

In Block 210, a prompt is generated for the document conversion LM. The prompt includes the identified differences as inputs. The prompt further includes instructions to generate a natural language summary of the identified difference(s), based on context information obtained from converted and CAG documents. In one or more embodiments, the prompt to the document conversion LM may include the identified difference(s) as input. Further, the prompt may include an instruction to generate the natural language summary based at least on a context of the converted document corresponding to the CAG field identifier of the converted document, and a context of the CAG document corresponding to the CAG field identifier of the CAG document. The prompt may be processed by the document conversion LM to generate a natural language summary of the identified difference(s). In one or more embodiments, the reconciliation engine may collect the identified differences and corresponding context information from the reconciliation data structures, the converted document and the CAG document, to generate the prompt inputs.

In Block 212, the natural language summary is presented to the customer via a web interface of the client application. In one or more embodiments, the identified difference(s) may be presented with the natural language summary in the client application. In generating the natural language summary for the identified difference(s), the document conversion LM may use the Local Interpretable Model-agnostic Explanations (LIME) technique. As a brief overview, LIME creates perturbations in the input data and the changes in the model output may be observed, facilitating identification of the part of the input data that is most influential in the generation of the natural language summary.

In Block 214, feedback is obtained from the customer on the accuracy of the natural language summary and identified differences. In one or more embodiments, feedback on the first difference and the natural language summary may be obtained from the client application. The feedback may be stored in a cumulative client feedback store. By way of example, customers may confirm if the identified difference was accurate. The identified difference may be incorrect, if, at the time of conversion, the canonical field identifier was misclassified with an incorrect CAG field identifier, resulting in an incorrect replacement. In the example, the original canonical field identifier may be “Capital Gain”:90000.” In the conversion process, the canonical field identifier “Capital Gain” may be misclassified as “Series 51 code 802” which is the CAG field identifier for “Wages Earned.” Thus, the reconciliation engine may flag the field values as different, when, in fact, the field identifiers are not the same. Thus, the customers may identify that the field identifier was wrongly classified, and that “Capital Gain” should in fact be classified/converted as “Series 51 code 902.”. In one or more embodiments, information stored in the cumulative client feedback store may include the canonical document, the converted document, the customer identification of errors, etc.

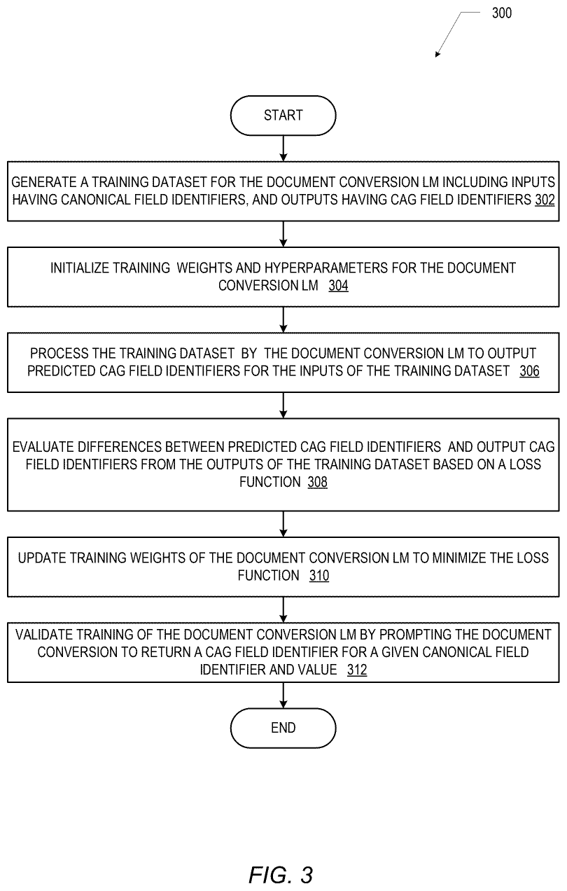

FIG. 3 shows a flowchart 300 of a method for training the document conversion LM, in accordance with one or more embodiments. The method of FIG. 3 may be implemented using the system of FIG. 1 and one or more of the steps may be performed on or received at one or more computer processors. While the various steps in flowchart 300 are presented and described sequentially, at least some of the steps may be executed in different orders, may be combined, or omitted, and at least some of the steps may be executed in parallel. Furthermore, the steps may be performed actively or passively.

In Block 302, a training dataset is generated for the document conversion LM. The training dataset includes inputs having canonical field identifiers, and outputs having CAG field identifiers. In one or more embodiments, a training application may generate the training dataset. The training dataset may be in the data-interchange format of the CAG document and converted document. The training dataset may include an input. The input may further include a canonical field identifier and a corresponding canonical field value. The training dataset may include an output corresponding to the input. The output may further include a CAG field identifier. The training dataset may further include a context descriptor of the canonical field identifier. Additionally, the training dataset may include a context descriptor of the CAG field identifier. In one or more embodiments, the training application may be a component of the reconciliation engine. In other embodiments, the training application may be a stand-alone computer program executing on the server computing system, programmatically invokable by the reconciliation engine. The training dataset inputs and outputs may be generated based on the document field mapping in the data repository. The document field mapping may map variations of canonical field identifiers to a single CAG field identifier. For example, canonical field identifiers such as “Wages,” “Income,” “Earnings” from a particular section may be mapped to the same CAG field identifier. The training dataset accordingly captures these variations.

In Block 304, training weights and hyperparameters for the document conversion LM may be initialized. In one or more embodiments, the training application may initialize the training weights and hyperparameters. In case of the document training LM being a BERT model, the training weights may include embedding layer weights, mapping input tokens to dense vectors. The training weights may further include transformer layer weights of multi-head self-attention mechanisms and feed-forward neural network weights. The training weights may further include output layer weights mapping the final hidden states to the output labels.

In Block 306, the training dataset is processed by the document conversion LM to output predicted CAG field identifiers for the inputs of the training dataset. In one or more embodiments, the training dataset may be processed by the document conversion LM to generate a predicted CAG field identifier corresponding to the canonical field identifier of the input of the training dataset. The step of Block 306 may be considered to be a “forward pass” of the training dataset through the document conversion LM.

In Block 308, the differences between predicted CAG field identifiers and output CAG field identifiers from the outputs of the training dataset are evaluated, based on a loss function. In one or more embodiments, the difference between the predicted CAG field identifier and the CAG field identifier of the corresponding output of the training dataset may be evaluated. The loss function used for evaluation may be a Cross-Entropy Loss function. As a brief overview, the Cross-Entropy Loss function measures the performance of a classification model whose output is a probability value between 0 and 1. In the case of the document conversion LM, the probability distribution of the predicted CAG identifiers may be compared with the actual distribution of the output CAG identifiers.

In Block 310, the training weights of the document conversion LM are updated to minimize the loss function. In one or more embodiments, the training weights and the hyperparameters of the document conversion LM may be updated based on an optimization function, to minimize the loss function. In one embodiment, the optimization function may be the Adaptive Movement Estimation (Adam) optimizer function. As a brief overview, the Adam function adjusts a learning rate individually for each parameter based on first and second moments of the gradients. Further, Adam uses momentum to accelerate the optimization process by considering the past gradients to smooth the updates and avoid oscillations. Furthermore, Adam includes bias correction terms to counteract the initial bias of in-the-moment estimates, during the early stages of training. In one or more embodiments, the gradients of the loss with respect to the document conversion LM's parameters may be computed using backpropagation. Further, the optimization function may update the parameters of the document conversion LM using the computed gradients.

In Block 312, the training of the document conversion LM may be validated, by prompting the document conversion LM to return a CAG field identifier for a given canonical field identifier and value. Additionally, or alternatively, the document conversion LM may be evaluated by processing a validation dataset to obtain outputs, which are evaluated for accuracy. Based on the evaluation, the document conversion LM may be fine-tuned with noise. A technique of fine-tuning with noise may be Layer-wise Noise Stability Regularization (LNSR). LNSR involves adding noise to the input or intermediate layers during training.

The method of FIG. 3 may additionally be used to re-train the document conversion LM. The document conversion LM may be re-trained based on the cumulative client feedback, at specified time intervals, to improve performance and accuracy. In one or more embodiments, the training application may generate a new training dataset The new training dataset may include an input, including a canonical field identifier and a corresponding canonical field value. The new training dataset may further include a corresponding output, including a corrected CAG field identifier obtained from the cumulative client feedback store. The new training dataset may further include a context descriptor of the canonical field identifier. The new training dataset may be in the data-exchange format of the CAG document(s). The document conversion LM training weights and hyperparameters may be initialized. Further, the training dataset may be processed by the document conversion LM to generate a predicted CAG field identifier corresponding to the canonical field identifier of the input of the training dataset. The difference between the predicted CAG field identifier and the corrected CAG field identifier of the corresponding output of the training dataset may be evaluated using a loss function. The training weights and the hyperparameters of the document conversion LM may be updated based on the optimization function to minimize the loss function.

FIG. 4 shows an example of a training dataset, in accordance with one or more embodiments. The following example is for explanatory purposes only and not intended to limit the scope of one or more embodiments.

Blocks 402 through 406 show examples of training data in JSON format. The training data captures variations of canonical field identifiers across different sections of a canonical document such as an IRS transcript. For example, in Block 402, Tax Line Items including “Wages,” “Earning,” and “Income,” are mapped to the same CAG field identifier, namely, “series 51 code 802.” Block 404 shows a different type of canonical field, namely, lock_key, for the tax line items. In Block 404, “Wages” and “Capital Gains” are mapped to different CAG field identifiers. Similarly, Block 406 shows Product C as having another canonical field type, namely, “check-execute.” The mapping assignations to the CAG field identifiers depend on the field type. For example, if the field type is “lock_key,” then the CAG field identifier is “lock 97 key 802,” for tax line item “Wages,” as shown in Block 404. In contrast, if the field type is “check_execute,” then the CAG field identifier for tax line item “Wages” is “check 87 execute 802,” as shown in Block 406.

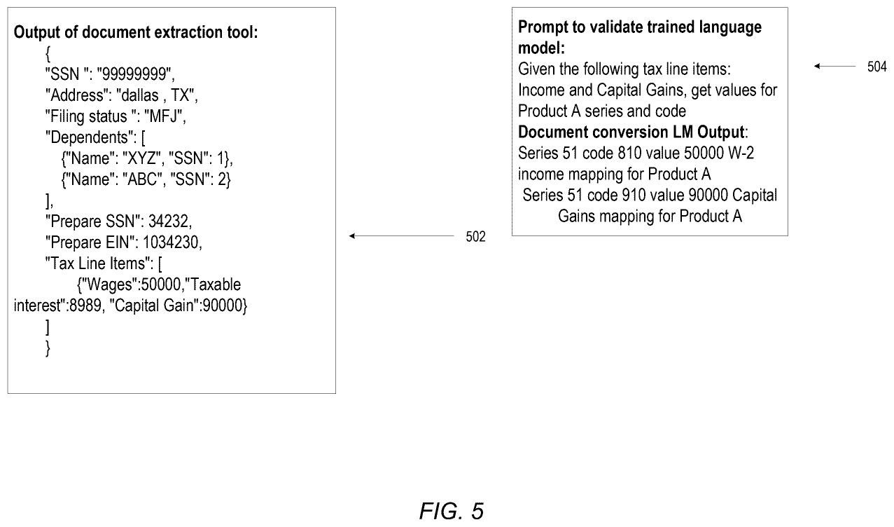

FIG. 5 shows other examples of selected system component outputs, in accordance with one or more embodiments. The following example is for explanatory purposes only and not intended to limit the scope of one or more embodiments. Block 502 shows an example of the document extraction tool output. The extracted document may include entries as shown in Block 502. The format of the output is human-readable and machine-readable, in a data-interchange format similar to the data-interchange format of a CAG document. Block 504 shows a test prompt to the trained document conversion LM, with and the corresponding output. The prompt includes tax line items from converted documents. The document conversion LM correctly responds with the series and code identifiers corresponding to the CAG documents.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining an extracted document corresponding to a customer, the extracted document comprising a plurality of canonical field identifiers and a corresponding plurality of canonical field values;
generating a first prompt to a document conversion language model (LM) comprising the extracted document as a first input, and a first instruction to convert the extracted document;
processing the first prompt by the document conversion LM to obtain a converted document;
comparing the converted document and a client-application-generated (CAG) document corresponding to the customer to identify a first difference between the converted document and the CAG document;
generating a second prompt to the document conversion LM including the first difference as a second input;
processing the second prompt by the document conversion LM to generate a natural language summary of the first difference; and
presenting the first difference and the natural language summary in a client application.

2. The method of claim 1, further comprising:
processing, by a document extraction tool, a canonical document corresponding to the customer, to obtain a canonical field identifier and a corresponding canonical field value; and
generating, by the document extraction tool, the extracted document including the canonical field identifier and the corresponding canonical field value in a data-interchange format, wherein the data-interchange format is the data-interchange format of the CAG document.

3. The method of claim 2, further comprising:
obtaining the canonical document, wherein the canonical document includes the plurality of canonical field identifiers and the corresponding plurality of canonical field values, from an external data source.

4. The method of claim 1, wherein the first prompt further comprises:
the first instruction to convert the extracted document by classifying the plurality of canonical field identifiers with a plurality of CAG field identifiers corresponding to the CAG document; and
replacing the plurality of canonical field identifiers of the extracted document with the plurality of CAG field identifiers, to obtain the converted document.

5. The method of claim 1, further comprising:
generating, by a training application, a training dataset, wherein generating the training dataset comprises:
an input, including a canonical field identifier and a corresponding canonical field value,
a corresponding output, including a CAG field identifier, and
a context descriptor of the canonical field identifier,
wherein the training dataset is in a data-exchange format of the CAG document.

6. The method of claim 5, further comprising training the document conversion LM by performing operations comprising:
initializing training weights and hyperparameters of the document conversion LM;
processing the training dataset by the document conversion LM, to generate a predicted CAG field identifier corresponding to the canonical field identifier of the input of the training dataset;
evaluating a difference between the predicted CAG field identifier and the CAG field identifier of the corresponding output of the training dataset, using a loss function; and
updating the training weights and the hyperparameters of the document conversion LM based on an optimization function, to minimize the loss function.

7. The method of claim 1, further comprising comparing the converted document and the CAG document by performing operations comprising:
comparing, by a reconciliation engine,
a canonical field value of the converted document corresponding to a first CAG field identifier of the converted document, and
a CAG field value of the CAG document corresponding to a second CAG field identifier of the CAG document, wherein the first CAG field identifier matches the second CAG field identifier, and
responsive to a mismatch between the canonical field value and the CAG field value, identifying the first difference.

8. The method of claim 7, wherein the second prompt further comprises a second instruction to generate the natural language summary based at least on:
a first context of the converted document corresponding to the first CAG field identifier, and
a second context of the CAG document corresponding to the second CAG field identifier.

9. The method of claim 1, further comprising:
obtaining, from the client application, feedback on the first difference and the natural language summary, and
storing the feedback in a cumulative client feedback store.

10. The method of claim 9, further comprising re-training the document conversion LM
by:
generating, by a training application, a new training dataset, comprising:
an input, including a canonical field identifier and a corresponding canonical field value,
a corresponding output, including a corrected CAG field identifier, wherein the corrected CAG field identifier is obtained from the cumulative client feedback store, and
a context descriptor of the canonical field identifier, wherein the new training dataset is in a data-exchange format of the CAG document.

11. The method of claim 10, further comprising:
initializing training weights and hyperparameters of the document conversion LM;
processing the new training dataset by the document conversion LM, to generate a predicted CAG field identifier corresponding to the canonical field identifier of the input of the new training dataset;
evaluating the difference between the predicted CAG field identifier and the corrected CAG field identifier of the corresponding output of the new training dataset, using a loss function; and
updating the training weights and the hyperparameters of the document conversion LM, based on an optimization function, to minimize the loss function.

12. A system, comprising:
at least one computer processor;
a document extraction tool, executing on the at least one computer processor configured to:
obtain an extracted document corresponding to a customer, comprising a plurality of canonical field identifiers and a corresponding plurality of canonical field values,
a document conversion language model (LM), executing on the at least one computer processor configured to:
process a first prompt to obtain a converted document, and
process a second prompt to generate a natural language summary of a first difference; and
a reconciliation engine, executing on the at least one computer processor; and configured to:
generate the first prompt to the document conversion LM including the extracted document as a first input, and a first instruction to convert the extracted document,
compare the converted document and a client-application-generated (CAG) document corresponding to the customer to identify the first difference between the converted document and the CAG document,
generate the second prompt to the document conversion LM including the first difference as a second input, and
present the first difference and the natural language summary in a client application.

13. The system of claim 12, wherein the document extraction tool is further configured to:
process a canonical document corresponding to the customer, to obtain a canonical field identifier and a corresponding canonical field value; and
generate the extracted document including the canonical field identifier and the corresponding canonical field value in a data-interchange format, wherein the data-interchange format is the data-interchange format of the CAG document.

14. The system of claim 13, further configured for:
obtaining the canonical document, wherein the canonical document includes the plurality of canonical field identifiers and the corresponding plurality of canonical field values, from an external data source.

15. The system of claim 12, wherein the first prompt further comprises:
the first instruction to convert the extracted document by classifying the plurality of canonical field identifiers with a plurality of CAG field identifiers corresponding to the CAG document, and
wherein the document conversion LM is further configured to:
replace the plurality of canonical field identifiers of the extracted document with the plurality of CAG field identifiers to obtain the converted document.

16. The system of claim 12, further comprising:
a training application executing on the at least one computer processor configured to generate a training dataset comprising:
an input, including a canonical field identifier and a corresponding canonical field value,
a corresponding output, including a CAG field identifier, and
a context descriptor of the canonical field identifier,
wherein the training dataset is in a data-exchange format of the CAG document.

17. The system of claim 16, further comprising a training application configured to perform operations comprising:
initializing training weights and hyperparameters of the document conversion LM, processing the training dataset by the document conversion LM, to generate a predicted CAG field identifier corresponding to the canonical field identifier of the input of the training dataset,
evaluating a difference between the predicted CAG field identifier and the CAG field identifier of the corresponding output of the training dataset, using a loss function, and
updating the training weights and the hyperparameters of the document conversion LM based on an optimization function, to minimize the loss function.

18. The system of claim 12, wherein comparing the converted document and the CAG document comprises:
comparing, by the reconciliation engine,
a canonical field value of the converted document corresponding to a first CAG field identifier of the converted document, and
a CAG field value of the CAG document corresponding to a second CAG field identifier of the CAG document, wherein the first CAG field identifier matches the second CAG field identifier; and
responsive to a mismatch between the canonical field value and the CAG field value, identifying the first difference.

19. The system of claim 18, wherein the second prompt further comprises a second instruction to generate the natural language summary based at least on a first context of the converted document corresponding to the first CAG field identifier, and a second context of the CAG document corresponding to the second CAG field identifier.

20. The system of claim 12, further comprising:
obtaining, from the client application, feedback on the first difference and the natural language summary, and
storing the feedback in a cumulative client feedback store.
